(19) United States
(12) Patent Application Publication
(10) Pub. No.: US 2010/0118922 A1
(43) Pub. Date: May 13, 2010

(54) WIRELESS REPEATER APPARATUS FOR CANCELING INTERFERENCE SIGNAL

(76) Inventor: Byung-Yang Ahn, Grenoble (FR)

Correspondence Address: MCDERMOTT WILL & EMERY LLP, 600 13TH STREET, N.W., WASHINGTON, DC, 20005-3096, US

(21) Appl. No.: 12/529,673

(22) PCT Filed: Nov. 23, 2007
(86) PCT No.: PCT/KR2007/005960

§ 371 Date: Sep. 2, 2009

(30) Foreign Application Priority Data
Mar. 6, 2007 (KR) 10-2007-0022060
Apr. 16, 2007 (KR) 10-2007-0037066

(51) Int. Cl. H04B 15/00

(52) U.S. Cl. 375/214

(57) ABSTRACT

There is provided a micro integrated wireless repeater apparatus for canceling an interference signal, including: a receiving means for receiving a repetition signal; an analog interference cancellation means for generating an interference cancellation signal according to a control signal and removing an interference signal from the repetition signal received from the receiving means; a digital interference cancellation means for canceling a residual interference signal remaining in a repetition signal obtained by canceling an interference signal component by the analog interference cancellation means; a control means for controlling the analog interference cancellation means by transmitting the control signal to the analog interference cancellation means according to control information received from the digital interference cancellation means; and a transmitting means for transmitting a repetition signal obtained by canceling a residual interference signal component by the digital interference cancellation means.

### TECHNICAL FIELD

The present invention relates to a wireless repeater apparatus for canceling an interference signal, a method for the wireless repeater apparatus, and a computer-readable recording medium storing a program for realizing the method; and, more particularly, to a micro integrated wireless repeater apparatus for canceling an interference signal by using a digital interference canceller and an analog interference canceller (e.g., an RF interference canceller) in an organic manner, a method for the wireless repeater apparatus, and a computer-readable recording medium storing a program for realizing the method.

### BACKGROUND ART

In general, a wireless repeater apparatus used in a mobile communication system is installed in a transmission section in order to service a high-quality signal to a mobile communication terminal located in a shadow area. Since transmit/receive (TX/RX) antennas of the wireless repeater apparatus are installed adjacent to each other, some of signals transmitted through the TX antenna are inversely received through the RX antenna, which greatly affects the quality of a signal to be repeated.

Therefore, a variety of technologies have been developed to cancel an interference signal received inversely as above. Examples of such technologies will be described with reference to FIGS. 1 and 2.

FIG. 1 is a block diagram of a conventional wireless repeater apparatus using a general analog interference canceller.

Referring to FIG. 1, a conventional wireless repeater apparatus using a general analog interference canceller includes: a donor antenna 100 for receiving a forward repetition signal (i.e., a signal to be repeated in a forward direction) from a base station; a donor band-pass filter 101 for band-pass filtering the forward repetition signal received through the donor antenna 100; an RF interference cancellation signal generator 105 for generating an interference cancellation signal using a forward repetition signal divided by a divider 104; a synthesizer (i.e., an interference signal canceller) 102 for removing an interference signal from a forward repetition signal received from the donor band-pass filter 101 by using the interference cancellation signal generated by the RF interference cancellation signal generator 105; a repetition amplifier 103 for amplifying a forward repetition signal received from the synthesizer 102; the divider 104 for dividing the amplified forward repetition signal received from the repetition amplifier 103 and transmitting the divided signals to the RF interference cancellation signal generator 105 and a service band-pass filter 106; the service band-pass filter 106 for filtering a forward repetition signal received from the divider 104; and a service antenna 107 for transmitting a forward repetition signal received from the service band-pass filter 106 to a mobile communication terminal located in a service coverage area.

Herein, not only a forward repetition signal (i.e., a repetition target signal) but also an interference signal, which is a feedback of a portion of a signal transmitted through the service antenna 107, are included in a signal received through the donor antenna 100. Thus, in order to cancel the interference signal, the RF interference cancellation signal generator 105 generates an interference cancellation signal by using a forward repetition signal received from the divider 104, and transmits the generated interference cancellation signal to the synthesizer 102. Then, the synthesizer 102 removes an interference signal from a forward repetition signal received from the donor band-pass filter 101 by using the interference cancellation signal received from the RF interference cancellation signal generator 105.

When a feedback interference signal has a short delay time, the above-described conventional method can cancel an interference signal. However, when the feedback interference signal has a very long delay time, the hardware implementation complexity becomes very high, thus making it impossible to implement the above-described conventional method.

In order to solve the above-described problem of the conventional analog interference cancellation method, digital signal processing technologies have been developed to propose a digital interference cancellation method capable of canceling a feedback interference signal more accurately.

FIG. 2 is a block diagram of a conventional wireless repeater apparatus using a general digital interference canceller.

Referring to FIG. 2, a conventional wireless repeater apparatus using a general digital interference canceller includes: a donor antenna 200 for receiving a forward repetition signal (i.e., a signal to be repeated in a forward direction) from a base station; a donor band-pass filter 201 for band-pass filtering the forward repetition signal received through the donor antenna 200; a down-converter 202 for converting a forward repetition signal received from the donor band-pass filter 201 into a baseband signal; a digital converter 203 for converting a forward repetition signal received from the down-converter 202 into a digital signal; a digital interference canceller 204 for removing an interference signal from a forward repetition signal received from the digital converter 203; an analog converter 205 for converting a forward repetition signal received from the digital interference canceller 204 into an analog signal; an up-converter 206 for converting a forward repetition signal received from the analog converter 205 into an RF signal; a service band-pass filter 207 for band-pass filtering a forward repetition signal received from the up-converter 206; and a service antenna 208 for transmitting a forward repetition signal received from the service band-pass filter 207 to a mobile communication terminal located in a service coverage area.

Herein, not only a forward repetition signal (i.e., a repetition target signal) but also an interference signal, which is a feedback of a portion of a signal transmitted through the service antenna 208, are included in a signal received through the donor antenna 200. Thus, in order to cancel the interference signal, the digital converter 203 converts a forward repetition signal (i.e., a repetition target signal containing an interference signal) down-converted by the down-converter 202 into a digital signal, and transmits the digital signal to the digital interference canceller 204. Then, the digital interference canceller 204 detects a feedback signal and cancels an interference signal contained in a forward repetition signal to achieve a gain.

The above-described conventional digital interference cancellation method can cancel an interference signal regardless of the delay time of a fed-back interference. However, when an interference signal is very strong, the conventional digital interference cancellation method degrades in interference cancellation performance and thus has a limitation in the interference cancellation performance.

As the demand for a mobile wireless Internet increases, the number of shadow areas increases and thus the number of installation places for wireless repeater apparatuses increases. Therefore, micro miniaturization of the wireless repeater apparatus is strongly required. Since the micro wireless repeater apparatus has a very small distance between a donor antenna and a service antenna, a direct feedback signal becomes very strong. Therefore, the conventional digital interference canceller fails to process a strong interference signal, thus making it impossible to achieve a large interference cancellation gain.

### DISCLOSURE

Technical Problem

An embodiment of the present invention is directed to providing a micro integrated wireless repeater apparatus for canceling an interference signal by using a digital interference canceller and an analog interference canceller (e.g., an RF interference canceller) in an organic manner, a method for the wireless repeater apparatus, and a computer-readable recording medium storing a program for realizing the method.

Another embodiment of the present invention is directed to providing a micro integrated wireless repeater apparatus for canceling an interference signal, which can increase the stability of signal repetition and enhance the signal quality by removing a feedback signal component from a repetition target signal by using a digital interference canceller and an analog interference canceller (e.g., an RF interference canceller) in an organic manner, a method for the wireless repeater apparatus, and a computer-readable recording medium storing a program for realizing the method.

A further embodiment of the present invention is directed to providing a micro integrated wireless repeater apparatus for canceling an interference signal where a donor antenna must be physically close to a service antenna, which can achieve a large interference cancellation gain, increase the stability of signal repetition and enhance the signal quality by getting a digital interference canceller to remove a residual interference signal component after getting an analog interference canceller (e.g., an RF interference canceller) to remove an interference signal component, which has a short time delay and a high interference level (i.e., a strong signal interference) in an RF domain, according to a control signal received from the digital interference canceller, a method for the wireless repeater apparatus, and a computer-readable recording medium storing a program. for realizing the method.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

Technical Solution

In accordance with an aspect of the present invention, there is provided a micro integrated wireless repeater apparatus for canceling an interference signal, including: a receiving means for receiving a repetition signal; an analog interference cancellation means for generating an interference cancellation signal according to a control signal and removing an interference signal from the repetition signal received from the receiving means; a digital interference cancellation means for canceling a residual interference signal remaining in a repetition signal obtained by canceling an interference signal component by the analog interference cancellation means; a control means for controlling the analog interference cancellation means by transmitting the control signal to the analog interference cancellation means according to control information received from the digital interference cancellation means; and a transmitting means for transmitting a repetition signal obtained by canceling a residual interference signal component by the digital interference cancellation means.

Advantageous Effects

In accordance with the present invention as described above, a micro integrated wireless repeater apparatus for canceling an interference signal, in which a donor antenna must be physically close to a service antenna, can increase the stability of signal repetition and enhance the signal quality by removing a feedback signal component from a repetition target signal by using a digital interference canceller and an analog interference canceller (e.g., an RF interference canceller) in an organic manner.

Also, a micro integrated wireless repeater apparatus for canceling an interference signal, in which a donor antenna must be physically close to a service antenna, can achieve a large interference cancellation gain, increase the stability of signal repetition and enhance the signal quality by getting a digital interference canceller to remove a residual interference signal component after getting an analog interference canceller (e.g., an RF interference canceller) to remove an interference signal component which has a short time delay and a high interference level (i.e., a strong signal interference) in an RF domain, according to a control signal received from the digital interference canceller.

### BRIEF DESCRIPTION OF THE DRAWINGS

FIG. 1 is a block diagram of a conventional wireless repeater apparatus using a general analog interference canceller.

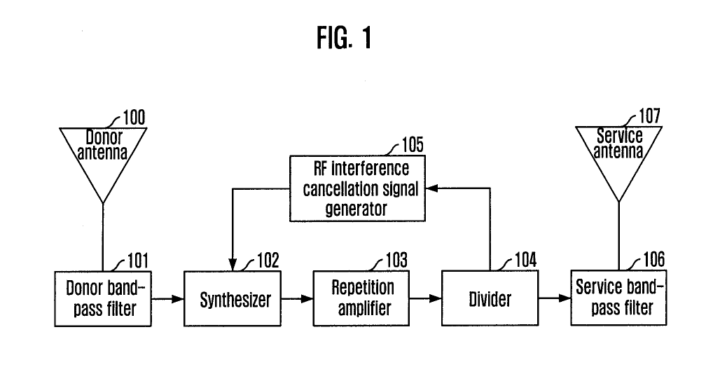

FIG. 2 is a block diagram of a conventional wireless repeater apparatus using a general digital interference canceller.

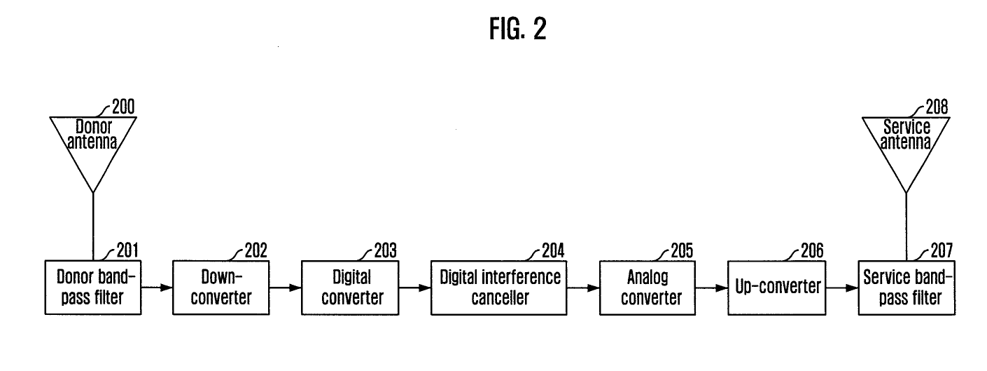

FIG. 3 is a block diagram of a micro integrated wireless repeater apparatus for canceling an interference signal in accordance with an embodiment of the present invention.

FIG. 4 is a block diagram of a digital interference canceling unit of FIG. 3 in accordance with an embodiment of the present invention.

FIG. 5 is a block diagram of an RF interference cancellation signal generator of FIG. 3 in accordance with an embodiment of the present invention.

FIG. 6 is a flow diagram illustrating a wireless repeating method for canceling an interference signal in accordance with an embodiment of the present invention.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that a detailed description on a related art may obscure the points of the present invention, the detailed description will not be provided herein. Hereinafter, the preferred embodiments of the present invention will be described in detail hereinafter with reference to the attached drawings.

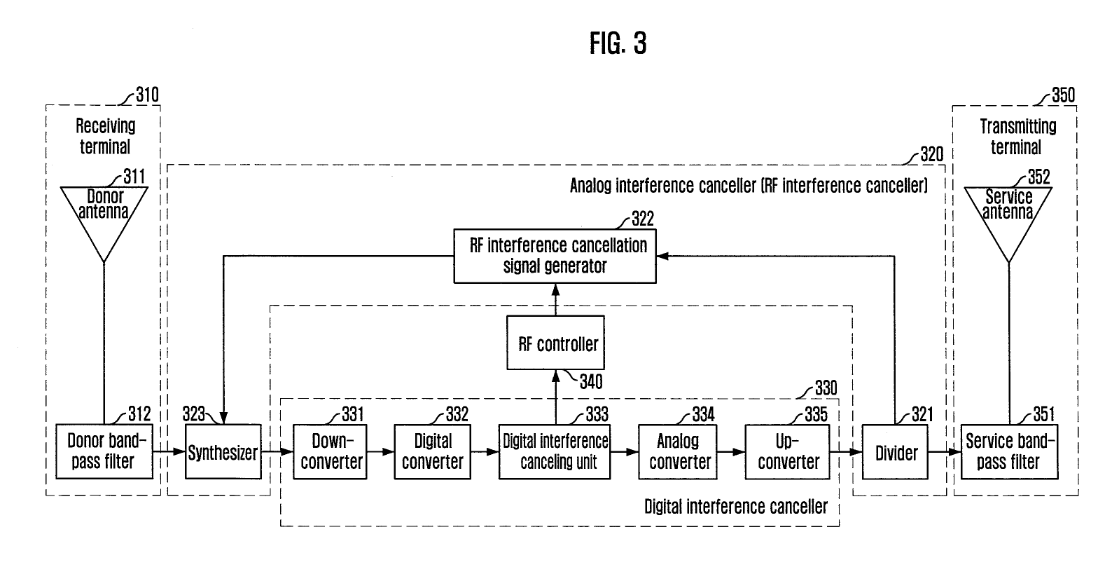

FIG. 3 is a block diagram of a micro integrated wireless repeater apparatus for canceling an interference signal in accordance with an embodiment of the present invention.

Since operations and constructions for a forward repetition signal are similar to operations and constructions for a reverse repetition signal, only the operations and constructions of the forward repetition signal will be described and a description of the operations and constructions of the reverse repetition signal will be omitted for conciseness.

Referring to FIG. 3, a micro integrated wireless repeater apparatus for canceling an interference signal in accordance with the present invention includes: a receiving terminal 310 for receiving a forward repetition signal (i.e., a signal to be repeated in a forward direction); an analog interference canceller (i.e., an RF interference canceller) 320 for generating an interference cancellation signal according to a control signal received from an RF controller 340 and removing an interference signal from a forward repetition signal received from the receiving terminal 310; a digital interference canceller 330 for canceling a residual interference signal remaining in a forward repetition signal obtained by canceling an interference signal component by the analog interference canceller 320; the RF controller 340 for controlling the analog interference canceller 320 according to control information received from the digital interference canceller 330; and a transmitting terminal 350 for transmitting a forward repetition signal obtained by canceling a residual interference signal component by the digital interference canceller 330.

As described above, the analog interference canceller 320 primarily cancels an interference signal component, which has a short time delay (e.g., 300 ns or less) and a high interference level (e.g., an interference level about 20 dB higher than a primary signal to be repeated when the repeater apparatus has the maximum gain) in an RF domain, according to a control signal received from the digital interference canceller 330 through the RF controller 340, and then the digital interference canceller 330 detects a feedback signal and secondarily cancels a residual interference signal component contained in a forward repetition signal.

In detail, the receiving terminal 310 includes a donor antenna 311 and a donor band-pass filter 312. The analog interference canceller 320 includes a divider 321, an RF interference cancellation signal generator 322, and a synthesizer 323. The digital interference canceller 330 includes a down-converter 331, a digital converter 332, a digital interference canceling unit 333, an analog converter 334, and an up-converter 335. The transmitting terminal 350 includes a service band-pass filter 351 and a service antenna 352.

Based on the above-described components, an overall description will now be given of the detailed connection and operation of the micro integrated wireless repeater apparatus for canceling an interference signal in accordance with the present invention.

The micro integrated wireless repeater apparatus for canceling an interference signal in accordance with the present invention includes: a donor antenna 311 for receiving a forward repetition signal (i.e., a signal to be repeated in a forward direction) from a base station; a donor band-pass filter 312 for band-pass filtering the forward repetition signal received through the donor antenna 311; an RF interference cancellation signal generator 322 for generating an interference cancellation signal using a forward repetition signal received from the divider 321; a synthesizer (i.e., an interference signal canceller) 323 for removing an interference signal from a forward repetition signal received from the donor band-pass filter 312 by using the interference cancellation signal received from the RF interference cancellation signal generator 322; a down-converter 331 for converting a forward repetition signal received from the synthesizer 323 into a baseband signal; a digital converter 332 for converting a forward repetition signal received from the down-converter 331 into a digital signal; a digital interference canceling unit 333 for removing a residual interference signal from a forward repetition signal received from the digital converter 332; the RF controller 340 for controlling the RF interference cancellation signal generator 322 according to control information received from the digital interference canceling unit 333; an analog converter 334 for converting a forward repetition signal received from the digital interference canceling unit 333 into an analog signal; an up-converter 335 for converting a forward repetition signal received from the analog converter 334 into an RF signal; the divider 321 for dividing a forward repetition signal up-converted by the up-converter 335 and transmitting the divided signals to the RF interference cancellation signal generator 322 and the service band-pass filter 351; the service band-pass filter 351 for band-pass filtering a forward repetition signal received from the divider 321; and the service antenna 352 for transmitting a forward repetition signal received from the service band-pass filter 351 to a mobile communication terminal located in a service coverage area.

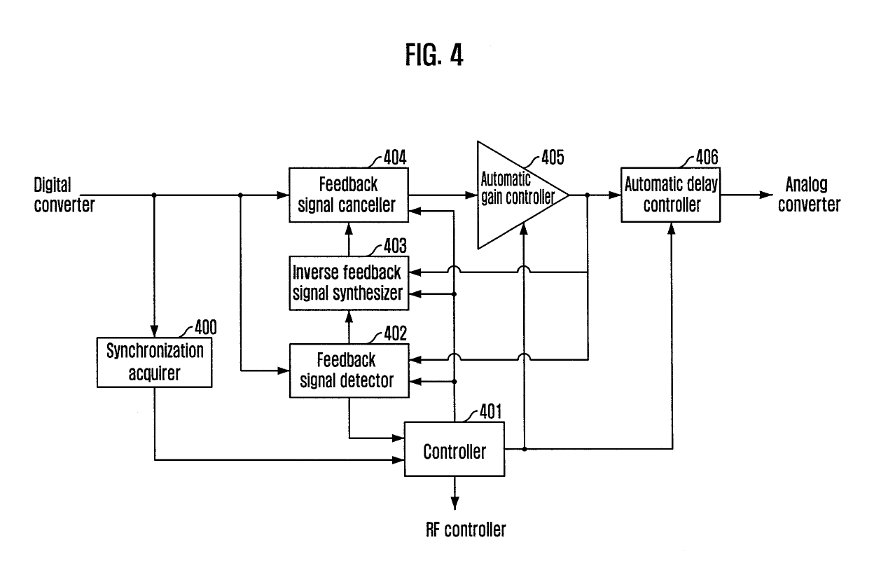

Herein, the RF controller 340 receives the control information for controlling the RF interference cancellation signal generator 322 from the digital interference canceling unit 333, which will be described later with reference to FIG. 4. One of the forward repetition signals divided by the divider 321 is transmitted to the RF interference cancellation signal generator 322 and is used to generate the RF interference cancellation signal, while the other of the divided forward repetition signals is transmitted to the service band-pass filter 351 and is repeated.

FIG. 4 is a block diagram of the digital interference canceling unit 333 of FIG. 3 in accordance with an embodiment of the present invention.

Referring to FIG. 4, the digital interference canceling unit 333 of the present invention includes: an automatic gain controller 405 for automatically controlling the gain (i.e., the output signal size) of a forward repetition signal to be repeated; a feedback signal detector 402 for detecting the phase, size (amplitude), time delay of a residual feedback signal contained in the forward repetition signal from a baseband digital forward repetition signal received from the automatic gain controller 405 and a baseband digital forward repetition signal received from the digital converter 332, and updating the phase, size (amplitude) and time delay of the feedback signal; an inverse feedback signal synthesizer 403 for generating an inverse feedback signal to be used to cancel the residual feedback signal contained in the forward repetition signal by using the baseband digital forward repetition signal received from the automatic gain controller 405 and the phase, size (amplitude) and time delay of the feedback signal received from the feedback signal detector 402; a feedback signal canceller 404 for canceling the residual feedback signal contained in the digital forward repetition signal received from the digital converter 332 by using the inverse feedback signal received from the inverse feedback signal synthesizer 403, and transmitting the resulting signal to the automatic gain controller 405; an synchronization acquirer 400 for acquiring a synchronization with the base station (or a communication terminal in a service coverage area) by using the digital forward repetition signal received from the digital converter 332; and a controller 401 for canceling the residual feedback signal contained in the forward repetition signal by using base station information and a synchronization signal received from the synchronization acquirer 400, controlling the respective components to transmit the forward repetition signal, and transmitting control information to the RF controller 340 according to update information received from the feedback signal detector 402.

Herein, the synchronization acquirer 400 is essential to, for example, a TDD wireless repeater apparatus and is used to extract a synchronization signal necessary for accurately controlling a signal flow in a forward direction (from base station to mobile communication terminal) or in a reverse direction (from mobile communication terminal to base station). This synchronization signal extraction (or acquisition) process is performed to detect a signal (i.e., a preamble) located at the start of a downlink from the base station to the mobile communication terminal. The preamble is configured to efficiently extract a synchronization signal in a TDD scheme, and base station information such as an ID of the base station and segment information can be additionally acquired in an acquisition process for the synchronization signal. In this way, the synchronization acquirer 400 acquires the synchronization signal, detects the base station information, and transmits the information to the controller 401. Then, the controller 401 controls a TDD-based wireless repeating operation by using the base station information and the synchronization signal received from the synchronization acquirer 400.

Herein, when the synchronization acquirer 400 acquires a synchronization signal stably for more than a predetermined time period (e.g., more than about 3 seconds that is a time period that can be regarded as the same signal strength over a plurality of frames) under the condition of more than a predetermined signal size (e.g., more than about 1/10 of an average input signal size), it applies the synchronization signal to the controller 401. On the other hand, when synchronization is not acquired, no synchronization signal is applied to the controller 401 so that all of the operations of the wireless repeater apparatus are stopped until the synchronization is acquired. Although not illustrated in the drawings, the synchronization acquirer 400 controls the downlink in consideration of a signal processing time period spent in the respective components 401 to 405 and a time period spent in the filters and other components.

The feedback signal detector 402 may estimate a feedback signal component by using the base station ID acquired by the synchronization acquirer 400. That is, since the base station ID is constructed using a pseudo noise (PN) code, the phase, size (amplitude) and time delay of the feedback signal may be estimated by calculating the correlation between the base station ID and the forward repetition signal. Therefore, the feedback signal detector 402 detects the phase, size (amplitude) and time delay of the residual feedback signal contained in the forward repetition signal by calculating the correlation between the base station ID received from the controller 401 and the forward repetition signal received from the automatic gain controller 405 and the digital converter 332, and transmits the detected information to the inverse feedback signal synthesizer 403.

The automatic gain controller 405 determines a gain value by using the size of the forward repetition signal received from the feedback signal canceller 404, a gain control value according to the current state, a target gain value, and a predetermined target output size value received from the controller 401, and uses the determined gain value to automatically control the gain (i.e., the output signal size) of the forward repetition signal obtained by canceling the feedback signal by the feedback signal canceller 404. For example, the automatic gain control is performed as follows: When the output value is greater than the predetermined target output size value, the automatic gain controller 405 limits the output size in order not to increase the gain any more. On the other hand, when the output value is smaller than the predetermined target output size value, the automatic gain controller 405 increases the gain by a predetermined unit time (e.g., 3 dB/1 second) until the size of the signal received from the feedback signal canceller 404 reaches the target gain value.

The feedback signal canceller 404 removes a feedback signal from the forward repetition signal received from the digital converter 332 by using the inverse feedback signal received from the inverse feedback signal synthesizer 403, and transmits the resulting signal to the automatic gain controller 405.

That is, the feedback signal canceller 404 cancels the residual feedback signal contained in the forward repetition signal by synthesizing the forward repetition signal received from the digital converter 332 and the inverse feedback signal received from the inverse feedback signal synthesizer 403, and then transmits the resulting forward repetition signal to the automatic gain controller 405.

Using the baseband forward repetition signal received from the automatic gain controller 405 and the phase, size (amplitude) and time delay of the feedback signal received from the feedback signal detector 402, the inverse feedback signal synthesizer 403 controls the phase, size (amplitude) and time delay of the signal used for canceling the feedback signal contained in the forward repetition signal, thereby generating the inverse feedback signal.

Using the synchronization signal received from the synchronization acquirer 400, the controller 401 detects the timing of the downlink to control a signal flow from the base station to the mobile communication terminal. Also, using the base station information received from the synchronization acquirer 400, the controller 401 transmits a code (e.g., the base station ID) necessary for detection of the feedback signal to the feedback signal detector 402. Then, the feedback signal detector 402 updates the phase, size (amplitude) and time delay of the feedback signal and then transmits the corresponding update control information to the controller 401. Then, the controller 401 transmits control information such as the updated phase, size (amplitude) and time delay to the RF controller 340 so that the RF controller 340 can control the update elements of the RF interference cancellation signal generator 322. According to the synchronization acquisition results of the synchronization acquirer 400 with respect to the synchronization from the base station to the mobile communication terminal, the controller 401 controls the operations of the automatic gain controller 405, the feedback signal detector 402, the inverse feedback signal synthesizer 403, and the feedback signal canceller 404. If a transmission signal is contained in a reception signal, that is, if the synchronization signal and the base station information are acquired by the synchronization acquirer 400, the controller 402 normally operates the automatic gain controller 405, the feedback signal detector 402, the inverse feedback signal synthesizer 403, and the feedback signal canceller 404. In this case, the target output size value is preset to a predetermined value and is transmitted to the automatic gain controller 405. On the other hand, if a transmission signal is not contained in a reception signal, that is, if the synchronization signal is not acquired by the synchronization acquirer 400, the controller 401 stops the operations of the automatic gain controller 405, the feedback signal detector 402, the inverse feedback signal synthesizer 403, and the feedback signal canceller 404.

Meanwhile, the digital interference canceling unit 333 further includes an automatic delay controller 406 for preventing a mutual interference between the feedback signal and a multi-path signal. That is, in order for the feedback signal to be able to be generated when a multi-path signal is not received, the automatic delay controller 406 is connected to the automatic gain controller 405 to control the generation delay of the feedback signal so that the feedback signal can be cancelled under the condition that the multi-path signal and the feedback signal do not overlap each other. To this end, the wireless repeater apparatus beforehand detects the position of a multi-path component, that is, the time when the multi--path signal is generated.

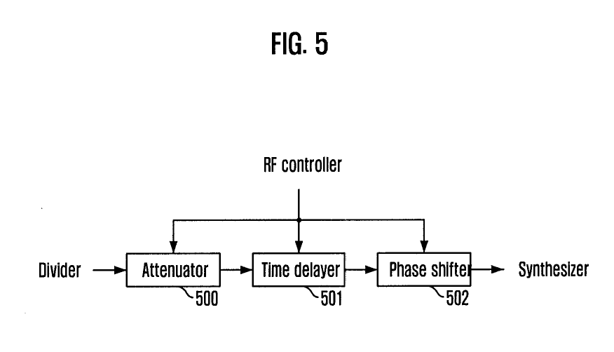

FIG. 5 is a block diagram of the RF interference cancellation signal generator 322 of FIG. 3 in accordance with an embodiment of the present invention.

Referring to FIG. 5, the RF interference cancellation signal generator 322 of the present invention includes: an attenuator 500 for attenuating, according to a control signal received from the RF controller 340, the level (i.e., strength) of the forward repetition signal containing the feedback interference signal received from the divider 321; a time delayer 501 for controlling (or compensating) the time delay for a forward repetition signal received from the attenuator 500 according to a control signal received from the RF controller 340; and a phase shifter 502 for shifting the phase of a forward repetition signal received from the time delayer 501 according to a control signal received from the RF controller 340.

Herein, the phase-shifted forward repetition signal of the phase shifter 502 is transmitted to the synthesizer 323 in order to cancel an interference signal.

Then, the synthesizer 323 synthesizes the interference cancellation signal received from the RF interference cancellation signal generator 322 and the forward repetition signal received from the donor band-pass filter 312, to remove an interference signal from the forward repetition signal containing the feedback interference received from the donor band-pass filter 312.

At this point, an interference component having a short time delay is cancelled by the analog interference canceller (RF interference canceller) 320, but the residual interference signal having a long time delay is not cancelled as yet. Thus, the residual interference signal is cancelled by the digital interference canceller 330.

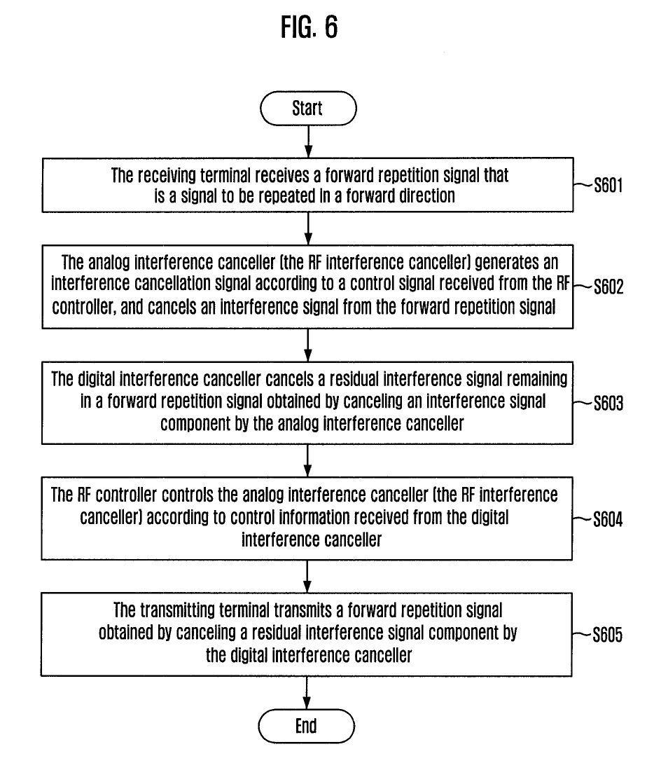

FIG. 6 is a flow diagram illustrating a wireless repeating method for canceling an interference signal in accordance with an embodiment of the present invention. In the wireless repeating method, a forward repetition signal is repeated, and then a feedback signal remaining in a subsequent forward repetition signal is cancelled by using the resulting feedback signal.

For example, in the case of a downlink in a TDD wireless repeating scheme, a signal received from the interference canceller 320/330 through a path from the donor antenna 311 to the donor band-pass filter 312 may contain both of a repetition signal that is transmitted from a base station for repeating an actual service and a feedback signal that is a feedback of a signal transmitted through the service antenna 352, or main contain only a feedback signal containing a random noise. A base station transmission signal is represented as a multi-path signal due to a wireless channel environment, and the case where there is only a feedback signal in a signal received in the wireless repeater apparatus corresponds to the case where the base station does not transmits a transmission signal to the mobile communication terminal. This is similarly applied to an uplink from the mobile communication terminal to the base station, and thus a description will be given of only the downlink case for conciseness.

Since a specific embodiment and the operation according to the specific embodiment are the same as described above, a description will be given of only the essential points of the wireless repeating method for removing an interference signal according to the present invention.

Referring to FIG. 6, in operation S601, the receiving terminal 310 receives a forward repetition signal that is a signal to be repeated in a forward direction.

In operation S602, the analog interference canceller (the RF interference canceller) 320 generates an interference cancellation signal according to a control signal received from the RF controller 340, and cancels an interference signal from the forward repetition signal.

In operation S603, the digital interference canceller 330 cancels a residual interference signal remaining in a forward repetition signal obtained by canceling an interference signal component by the analog interference canceller 320.

In operation S604, the RF controller 340 controls the analog interference canceller (the RF interference canceller) 320 according to control information received from the digital interference canceller 330.

In operation S605, the transmitting terminal 350 transmits a forward repetition signal obtained by canceling a residual interference signal component by the digital interference canceller 330.

Although the analog interference cancellation operation S602, the digital interference cancellation operation S603, and the control operation S604 have been described as being performed in the above order, they may be performed in any other order because they are circulative operations.

The methods for canceling an interference signal in accordance with the embodiments of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

While the present invention has been described with respect to the specific embodiments, it will be apparent to those skilled in the art that various changes and modifications may be made without departing from the spirit and scope of the invention as defined in the following claims.

What is claimed is:

1. A micro integrated wireless repeater apparatus for canceling an interference signal, comprising:
a receiving means for receiving a repetition signal;
an analog interference cancellation means for generating an interference cancellation signal according to a control signal and removing an interference signal from the repetition signal received from the receiving means;
a digital interference cancellation means for canceling a residual interference signal remaining in a repetition signal obtained by canceling an interference signal component by the analog interference cancellation means;
a control means for controlling the analog interference cancellation means by transmitting the control signal to the analog interference cancellation means according to control information received from the digital interference cancellation means; and
a transmitting means for transmitting a repetition signal obtained by canceling a residual interference signal component by the digital interference cancellation means.

2. The micro integrated wireless repeater apparatus of claim 1, wherein the control information received from the digital interference cancellation means includes information about phase, amplitude, and time delay.

3. The micro integrated wireless repeater apparatus of claim 2, wherein the analog interference cancellation means primarily cancels an interference signal component in an RF domain according to a control signal received from the digital interference cancellation means through the control means, and the digital interference cancellation means detects a feedback signal and secondarily cancels a residual interference signal component remaining in a repetition signal obtained by canceling an interference signal component by the analog interference cancellation means.

4. The micro integrated wireless repeater apparatus of claim 1, wherein the analog interference cancellation means comprises:
a divider for dividing a repetition signal received from the digital interference cancellation means;
an RF interference cancellation signal generator for generating an interference cancellation signal by using a repetition signal received from the divider; and
an interference signal canceller for removing an interference signal from a repetition signal received from the receiving means by using the interference cancellation signal received from the RF interference cancellation signal generator.

5. The micro integrated wireless repeater apparatus of claim 4, wherein the RF interference cancellation signal generator comprises:
an attenuator for attenuating the strength of the repetition signal received from the divider according to a control signal received from the control means;
a time delayer for controlling the time delay for a repetition signal received from the attenuator according to a control signal received from the control means; and
a phase shifter for shifting the phase of a repetition signal received from the time delayer according to a control signal received from the control means.

6. The micro integrated wireless repeater apparatus of claim 4, wherein the digital interference cancellation means comprises:
a down-converter for converting a repetition signal received from the interference signal canceller into a baseband signal;
a digital converter for converting a repetition signal received from the down-converter into a digital signal;
a digital interference canceling unit for removing a residual interference signal from a repetition signal received from the digital converter and transmitting control information including information about phase, amplitude and time delay to the control means;
an analog converter for converting a repetition signal received from the digital interference canceling unit into an analog signal; and
an up-converter for converting a repetition signal received from the analog converter into an RF signal and transmitting the RF signal to the divider.

7. The micro integrated wireless repeater apparatus of claim 6, wherein the digital interference canceling unit comprises:
an automatic gain controller for automatically controlling the gain of a repetition signal;
a feedback signal detector for detecting the phase, size (amplitude), time delay of a residual feedback signal from repetition signals received from the automatic gain controller and the digital converter, and updating the phase, size (amplitude) and time delay of the feedback signal;
an inverse feedback signal synthesizer for generating an inverse feedback signal by using the repetition signal received from the automatic gain controller and the phase, size (amplitude) and time delay of the feedback signal received from the feedback signal detector;
a feedback signal canceller for canceling the residual feedback signal existing in the repetition signal received from the digital converter by using the inverse feedback signal received from the inverse feedback signal synthesizer, and transmitting the resulting signal to the automatic gain controller;
an synchronization acquirer for acquiring a synchronization with an external device by using the repetition signal received from the digital converter; and
a controller for controlling the automatic gain controller, the feedback signal detector, the inverse feedback signal synthesizer, and the feedback signal canceller by using base station information and a synchronization signal received from the synchronization acquirer, and transmitting control information including information about phase, amplitude (size), and time delay to the control means according to update information received from the feedback signal detector.

8. The micro integrated wireless repeater apparatus of claim 7, wherein the digital interference canceling unit further comprises an automatic delay controller for preventing a mutual interference between a multi-path signal and the feedback signal existing in the repetition signal under the control of the controller.

9. The micro integrated wireless repeater apparatus of claim 8, wherein in order for the feedback signal to be able to be generated when a multi-path signal is not received, the automatic delay controller is connected to the automatic gain controller to control the generation delay of the feedback signal under the control of the controller so that the feedback signal is able to be cancelled under the condition that the multi-path signal and the feedback signal do not overlap each other.

10. The micro integrated wireless repeater apparatus of claim 7, wherein the feedback signal detector detects the phase, size (amplitude) and time delay of the residual feedback signal existing in the repetition signal by calculating the correlation between the base station ID received from the controller and the repetition signal received from the automatic gain controller and the digital converter, and transmits the detected information to the inverse feedback signal synthesizer.

11. The micro integrated wireless repeater apparatus of claim 7, wherein the controller detects, by using the synchronization signal received from the synchronization acquirer, the timing of a link to control a signal flow of the repetition signal; transmits, by using the base station information received from the synchronization acquirer, a base station ID necessary for detection of the feedback signal to the feedback signal detector; transmits control information including information about the phase, size (amplitude) and time delay of the feedback signal received from the feedback signal detector to the control means; and controls the operations of the automatic gain controller, the feedback signal detector, the inverse feedback signal synthesizer, and the feedback signal canceller according to the synchronization acquisition results of the synchronization acquirer.

12. The micro integrated wireless repeater apparatus of claim 7, wherein the automatic gain controller determines a gain value by using the size of the repetition signal received from the feedback signal canceller, a gain control value according to the current state, a target gain value, and a predetermined target output size value received from the controller, and uses the determined gain value to automatically control the gain (the output signal size) of the repetition signal obtained by canceling the feedback signal by the feedback signal canceller.

13. A wireless repeating method for canceling an interference signal, comprising:
receiving a repetition signal;
performing an analog interference cancellation operation for generating an interference cancellation signal according to first control information used in an immediately previous digital interference cancellation operation and removing an interference signal from the received repetition signal;
performing a digital interference cancellation operation for canceling a residual interference signal remaining in a repetition signal obtained in the analog interference cancellation operation;
performing a control operation for controlling an immediately following analog interference cancellation operation according to second control information used in the digital interference cancellation operation; and
performing a transmitting operation for transmitting a repetition signal obtained by canceling the residual interference signal component in the digital interference cancellation operation.

14. The wireless repeating method of claim 13, wherein the control information includes information about phase, amplitude, and time delay.

15. The wireless repeating method of claim 13, wherein the analog interference cancellation operation comprises:
dividing a repetition signal obtained in the immediately previous digital interference cancellation operation;
generating an interference cancellation signal by using the divided repetition signal; and
removing an interference signal from the received repetition signal by using the generated interference cancellation signal.

16. The wireless repeating method of claim 15, wherein the digital interference cancellation operation comprises:
down-converting a repetition signal obtained by canceling an interference signal component in the analog interference cancellation operation into a baseband signal;
converting the down-converted repetition signal into a digital signal;
removing a residual interference signal from the digital repetition signal and transmitting control information including information about phase, amplitude and time delay;
converting a repetition signal obtained by canceling the residual interference signal into an analog signal; and
up-converting the analog repetition signal into an RF signal.

17. A computer-readable recording medium storing a program for performing a wireless repeating method in a micro integrated wireless repeater apparatus having a processor and removing an interference signal, the wireless repeating method comprising:
receiving a repetition signal;
performing an analog interference cancellation operation for generating an interference cancellation signal according to first control information used in an immediately previous digital interference cancellation operation and removing an interference signal from the received repetition signal;
performing a digital interference cancellation operation for canceling a residual interference signal remaining in a repetition signal obtained in the analog interference cancellation operation;
performing a control operation for controlling an immediately following analog interference cancellation operation according to second control information used in the digital interference cancellation operation; and
performing a transmitting operation for transmitting a repetition signal obtained by canceling the residual interference signal component in the digital interference cancellation operation.
